(19) United States
(12) Patent Application Publication
(10) Pub. No.: US 2008/0004527 A1
(43) Pub. Date: Jan. 3, 2008

(54) High-resolution ultrasound spectral and wavelet analysis of vascular tissue

(76) Inventors: D. Jackson Coleman, Haworth, NJ (US); Ronald H. Silverman, West Nyack, NY (US); Mark Rondeau, New York, NY (US)

Correspondence Address: SILLS CUMMIS EPSTEIN & GROSS P.C., ONE RIVERFRONT PLAZA, IP DEPARTMENT, NEWARK, NJ, 07102, US

(21) Appl. No.: 11/784,270

(22) Filed: Apr. 5, 2007

Related U.S. Application Data
(60) Provisional application No. 60/789,336, filed on Apr. 5, 2006.

(51) Int. Cl. G01N 29/34

(52) U.S. Cl. 600/437

(57) ABSTRACT

Images that map statistics of ultrasound backscatter obtained from wavelet decomposition of ultrasound parameter images are used to highlight spatial variation in scattering related to changes in the choroid's vascular conformation. Wavelet analysis ultrasound parameter images are used to identify changes in the scattering structure. The technique can also be applied to other vascular beds and other tissue, as well as non-biological material that can be interrogated with high frequency ultrasound.

### CROSS-REFERENCE TO RELATED APPLICATION

This application claims the benefit of U.S. Provisional Application No. 60/789,336, filed Apr. 5, 2006.

### STATEMENT REGARDING FEDERALLY SPONSORED RESEARCH

This invention was made with government support under Grant EB00238 awarded by the National Institute of Biomedical Imaging and Bioengineering and Grant CA84588 awarded by the National Cancer Institute. The government has certain rights to the invention.

### BACKGROUND OF THE INVENTION

1. Field of the Invention

The present invention relates to techniques for assessing the three dimensional structure of vascular tissue, and, more particularly, to high-resolution ultrasound imaging using a wavelet analysis of echo data to monitor vascular remodeling in tissue during the progression of disease.

2. Background

The ability to image and quantify tissue changes associated with vascular remodeling is of significant interest in a wide range of medical specialties. One way of evaluating these tissue changes is to examine modifications in flow characteristics from resolvable vessels. Most of the ultrasound units used in radiology departments include the capability of performing color-flow Doppler imaging for this purpose. Depictions of color-flow produced by such conventional Doppler systems must inherently have poorer resolution than the gray-scale ultrasound image of stationary tissues over which the color-flow information is superimposed. The relatively poor resolution of Doppler color-flow limits the vessel size and rate of flow detectable by such systems and ultimately the ability to detect vascular remodeling.

For example, an understanding of the pathogenesis of ophthalmic diseases, including glaucoma and age-related macular degeneration, as well as the mechanisms and effectiveness of treatment options, has been limited by the lack of appropriate tools and techniques. The clinical significance of an improvement in the management of ophthalmic diseases alone is substantial since it is estimated that about three million people in the United States alone suffer from glaucoma are at risk for vision loss from optic nerve damage due to increased intraocular pressure (IOP), and that more than six million people in the United States suffer from some form of degenerative retinal disease that leads to loss of functional vision.

High frequency ultrasound is useful as a clinical tool and technique in several areas of medicine. Measurement of blood flow using Doppler and non-Doppler methods are among the imaging and analysis techniques used with high frequency ultrasound.

One example of a time-domain technique for mapping flow based on acquisition of a series of spatially offset M-scans (a series of RF vectors acquired at fixed time intervals typically on a single line of sight) is disclosed in Ferrara, K. W., et al., “Estimation of Blood Velocity With High Frequency Ultrasound,” IEEE Trans Ultra Freq Cons., 43:149-157 (1996) which is herein incorporated by reference. By combining a series of M-scan determinations at independent adjacent spatial positions which are spaced at distances greater than the lateral resolution of the ultrasound beam, B-mode images with flow information can be produced. At each spatial position, groups of moving blood cells are detected and their range determined in successive vectors, from which their velocity is computed. When the data are acquired, two-dimensional (“2-D”) matrix and three-dimensional (3-D) flow maps can be produced using techniques, such as the one disclosed in Stith, A., et al., “3-D Ultrasonic Mapping of the Microvasculature,” Proc IEEE Ultrason Symp., 1473-1476 (1996) which is herein incorporated by reference.

A significant factor limiting the clinical utility of this technique arises from the intermittent nature of the scanning procedure. To scan a diagnostically useful lateral range, M-scan sequences must be acquired at approximately 256 or more spatially independent positions. For each of these positions, transducer motion must be initiated, motion stop confirmed, and data acquired and stored. These operations are time consuming, and can approach 0.5 seconds per position and can expend as much as one minute for a single plane. In the case of the eye, particularly, voluntary and involuntary motions over such a long period are inevitable.

Previous attempts to measure blood flow within the eye using conventional color Doppler ultrasound methods have also been limited by insensitivity to very slow velocities (<1.5 cm/s), as disclosed in T. H. Williamson and A. Harris, “Color Doppler ultrasound imaging of the eye and orbit,” Survey of Opthalmology, vol. 40, pp. 255-267, 1996, which is herein incorporated by reference, as well as the inability to resolve vessels smaller than 300 microns and the tortuousity of the vessels relative to the beam-width of the ultrasound. Studies have demonstrated the ability to assess blood flow in the ophthalmic artery and vein and in the short posterior ciliary artery, however these vessels are generally larger and contain higher flow velocities compared to those found in the anterior segment as disclosed in A. Harris, L. Kagemann, and G. A. Cioffi, “Assessment of human ocular hemodynamics”; Survey of Opthalmology, vol. 42, pp. 509-533, 1998 and T. H. Williamson and A. Harris, “Ocular blood flow measurement.” British Journal of Opthalmology, vol. 78, pp. 939-945, 1994, which are herein incorporated by reference.

Studies using high frequency ultrasound demonstrate the ability to resolve structures down to forty microns in the anterior segment of the eye as disclosed in C. J. Pavlin, D. A. Christopher, P. N. Burns, and F. S. Foster, “High-frequency Doppler ultrasound examination of blood-flow in the anterior segment of the eye,” American Journal of Opthalmology, vol. 126, pp. 597-600, 1998, and such B-scans of the eye are clinically useful in diagnosing diseases, such as melanoma of the ciliary body and open angle glaucoma as disclosed in C. J. Pavlin, “Practical application of ultrasound biomicroscopy,” Canadian Journal of Opthalmology, vol. 30, pp. 225-229, 1995, D. J. Coleman, S. Woods, M. J. Rondeau, and R. H. Silverman, “Ophthalmic ultrasonography.” Radiologic Clinics Of North America, vol. 30, pp. 1105-1114, 1992, and C. J. Pavlin, K. Harsiewicz, M. D. Sherar, and F. S. Foster, “Clinical use of ultrasound biomicroscopy” Opthalmology, vol. 98, pp. 287-295, 1991 which are herein incorporated by reference. High frequency Doppler studies (C. J. Pavlin, D. A. Christopher, P. N. Burns, and F. S. Foster, “High-frequency Doppler ultrasound examination of blood-flow in the anterior segment of the eye,” American Journal of Opthalmology, vol. 126, pp. 597-600, 1998), have difficulties with clutter discrimination, resolution, and possibly energy levels.

U.S. Pat. No. 6,547,731 to Coleman et al., which is herein incorporated by reference, provides for a method for assessing blood flow in a tissue involving sequentially directing a beam through the tissue along overlapping lines of sight and then generating blood flow data from echo data from where the ultrasonic beams overlap to evaluate blood flow in the tissue. More specifically, spatially overlapping beams are generated at fixed temporal intervals. Spatial overlap allows the spatial distance between overlapping lines-of-sight to be ignored, while moving reflectors within any overlapping line-of-sight will cause detectable changes in range of the moving reflector from one line-of-sight to the next. The rate of motion is determined from the measured change in range and the known time interval between vectors. Processing of data includes alignment of data between lines-of-sight to suppress artifactual motion and a wall filter for isolation of flow-data from stationary structures. In contrast to prior systems in which an ultrasonic pulse was repeatedly directed to a discrete line-of-sight, this method continuously scans over a region in order to rapidly assess blood velocities in blood vessels. A transducer can rapidly translate a beam across a region of interest in an overlapping pattern and sensitive maps of blood velocity in blood vessels can be constructed.

In addition to the prior art above, several new therapies to slow or stop choroidal neovascularization are currently undergoing extensive clinical evaluation, but evaluation of the choroid and blood flow is limited by present imaging techniques. However, none of these methods provided for high resolution imaging techniques.

### SUMMARY OF THE INVENTION

The present invention provides a unique new method that permits high resolution imaging of the choroidal architecture that supplement standard clinical measures.

Accordingly, a method of ultrasound imaging and analysis of a material of interest is provided, the method comprising conducting an ultrasound scan of the material of interest using a transducer that emits an acoustic signal, receiving a backscattered signal from a region in the material of interest, collecting transducer voltage data along an individual line of sight to form a one-dimensional array of radio frequency data, and applying a wavelet transform to the one-dimensional array of radio frequency data, where a transform function is determined by the properties of the material of interest. The material of interest can be the retina and choroid of an eye.

The method of ultrasound imaging and analysis of a material of interest further comprises identifying areas of interest in the scatter signal and masking out unwanted regions. The wavelet transform can comprise applying a one-dimensional discrete or continuous wavelet transform to transform the radio frequency data to a multiresolution quad-tree structure with a sparse coefficient representation. The method further comprises storing coefficients in a wavelet coefficient database, and evaluating changes between the wavelet coefficients using wavelet statistical modeling. The statistical modeling is performed from a process selected from a group consisting of: joint Gaussian models, joint non-Gaussian models, Hidden Markov models, independent component analysis and Bayesian formulations, amongst others.

The method of ultrasound imaging and analysis of a material of interest further comprises storing descriptive statistics and covariance structures for specific data distributions provided by the statistical modeling. The method further comprises creating images or maps using hypothesis testing or estimation techniques, where reconstructions of normalized wavelet coefficients are encoded. The method further comprises applying various hypothesis testing arrangements to local cliques of data by applying specific filters to wavelet data. The method further comprising classifying the wavelet data, and determining a status of the tissue or the material of interest using the wavelet data.

Further, a method of ultrasound imaging and analysis of a material of interest is provided, the method comprising conducting an ultrasound scan of the material of interest using a transducer that emits an acoustic signal, receiving a backscattered signal from a region in the material of interest, collecting transducer voltage data to obtain the radio frequency data along multiple lines of sight to form a two-dimensional array of radio frequency data, and applying a wavelet transform to the two-dimensional array of radio frequency data, where a transform function is determined by the properties of the material of interest.

The method of ultrasound imaging and analysis of a material of interest further comprises obtaining parameter images of the backscatter radio frequency data using short-windowed fast Fourier transform or wavelet transform. The method further comprises inputting the parameter images into a two-dimensional wavelet processing stream, and applying a two-dimensional discrete wavelet transform of the parameter images to produce a series of coefficient sub-bands.

The method of ultrasound imaging and analysis of a material of interest further comprises storing the coefficient sub-bands in a multiresolution analysis database, and evaluating changes between the wavelet coefficients using wavelet statistical modeling. The process of statistical models used are selected from a group consisting of: joint Gaussian models, joint non-Gaussian models, Hidden Markov models, independent component analysis and Bayesian formulations, amongst others.

The method further comprises creating images or maps using hypothesis testing or estimation techniques, where reconstructions off normalized wavelet coefficients are encoded, and applying various hypothesis testing arrangements to local cliques of data by applying specific filters to wavelet data. The method further comprises classifying the wavelet data, and determining a status of the tissue or the material of interest using the wavelet data.

The method of ultrasound imaging and analysis of a material of interest further comprises combining the images to produce a single fused image, and determining the material or tissue status using the single fused image.

Finally, a high resolution imaging system for imaging a material of interest is provided, the system comprising a transducer for emitting an acoustic signal and receiving a backscattered signal generated from a region in the material of interest such as the retina and choroid, a data processing system for acquiring radio frequency data along multiple lines of sight to from a two dimensional array of radio frequency data, applying a wavelet transform to the radio frequency data to form several images of the data, and forming a single fused image from the several images, and a display for displaying the single fused image to determine a material or tissue status.

The above and other features of the invention, including various novel details of construction and combinations of parts, will now be more particularly described with reference to the accompanying drawings and pointed out in the claims. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE DRAWINGS

These and other features, aspects, and advantages of the apparatus and methods of the present invention will become better understood with regard to the following description, appended claims, and accompanying drawings where:

FIGS. 1A and 1B are schematic diagrams illustrating wavelet based radio frequency ultrasound processing in accordance with the present invention; and

FIGS. 2A and 2B are schematic diagrams illustrating 2-dimensional wavelet parameter image processing in accordance with the present invention.

### DETAILED DESCRIPTION OF THE PREFERRED EMBODIMENT

Although this invention is applicable to numerous and various types of medical applications, it has been found particularly useful in ophthalmic applications dealing with very high-frequency ultrasound systems that can provide extremely high spatial resolution. Ophthalmic applications are of special interest because the eye's peripheral location allows us to use very high frequency ultrasound without the attenuation that would occur if these frequencies were used to image deeper structures. While ophthalmic applications shall be most fully discussed, it should not be construed that the invention is in any way limited to use for diagnosis of ocular disease. Similarly, it should not be construed that the technique is limited to use with very high frequency ultrasound. The method to be described is generally applicable to any ultrasonic frequency range and to any area of the body accessible to ultrasonic examination. Therefore, without limiting the applicability of the invention to the above, the invention will be described in such environment.

In the present invention, patients with age-related macular degeneration (ARMD) were recruited for high-resolution choroidal imaging in addition to fundus photography, Fluorescein Angiography (FA) and Optical Coherence Tomography (OCT) examinations of the retina. When performing ophthalmic fundus photography for diagnostic purposes, the pupil is dilated with eye drops and a special camera called a fundus camera is used to focus on the fundus or posterior portion of the eye. Fluorescein Angiography (FA) is a special technique performed which allows detailed analysis of the blood vessels of the retina and helps determine the seriousness of the retinopathy to plan for the mode of management. Optical Coherence Tomography (OCT) may also be recommended. Digital radio frequency (RF) scans of the macular region were acquired to examine backscatter changes in the retina, chorio-capillaris and choroid. Microarchitecture of vascular dimensions and thickness of the choroid were accurately imaged and measured. Then, wavelet analysis ultrasound parameter images (WAUPI) were used to identify changes in the scattering structure. Swept mode flow imaging of the retina and choroidal vessels down to 40 microns is used to demonstrate flow changes.

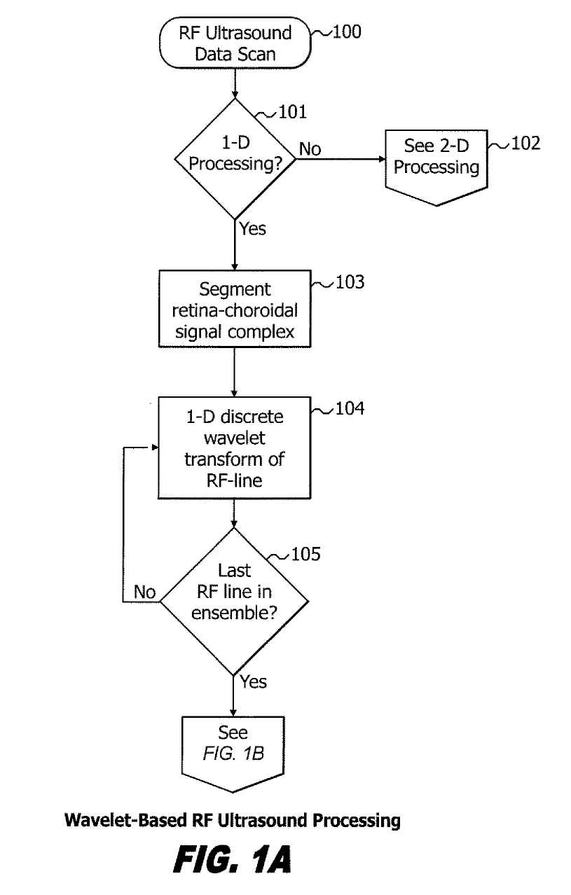

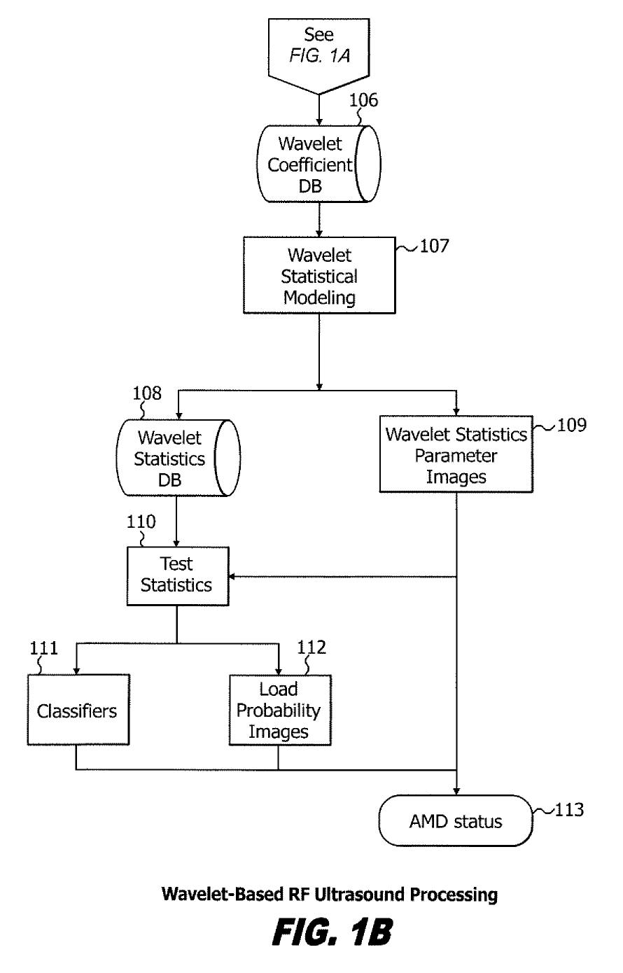

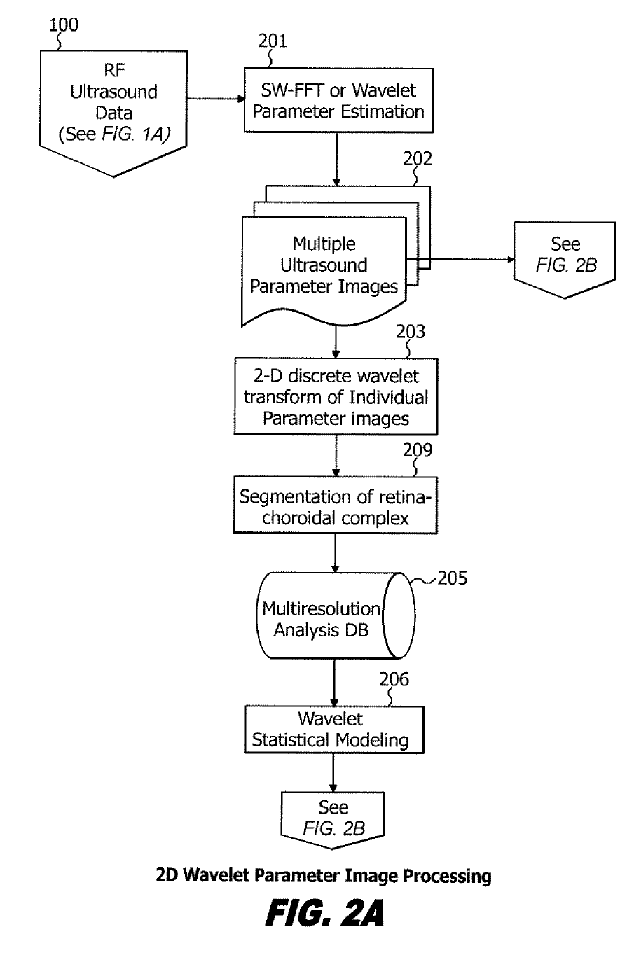

With reference now to the drawings, the apparatus and method of high resolution imaging of the present invention will be described. As seen in FIG. 1A, a Radio Frequency (RF) Ultrasound Data Scan 100 is first conducted on a material of interest, such as the choroid of an eye. Ultrasound data obtained in a laboratory is digitized at a raw amplifier level using high speed (400 MHz) 12-bit depth digitizers. This is not digitizing the Gray-scale ultrasonograms but rather the underlying RF lines (signals) and parameters derived from them.

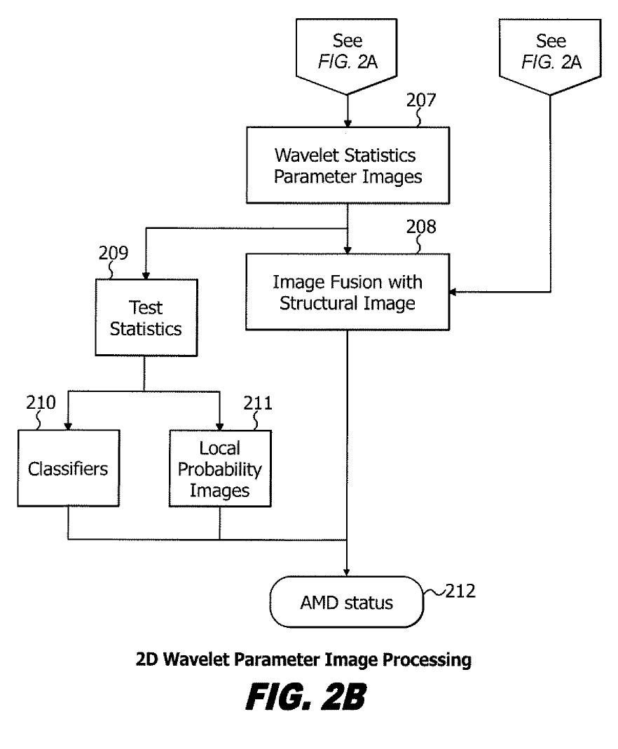

Then, either 1-D processing 101 or 2-D processing 102 is performed, which is basic data input to the processing stream. 1-D processing 101 is performed on ensembles of individual RF lines which axially traverse the retina-choroid and statistical correlations are obtained both within RF lines and from neighboring RF lines. 2-D processing refers to the use of parameter images (2-D representations of ultrasound characteristics based on mathematical models of scattering) as input to the processing stream. For purposes of illustration, the 1-D processing on individual RF lines is described in FIGS. 1A and 1B, and the 2-D processing 102 is later described in FIGS. 2A and 2B.

If 1-D processing is performed, then the segmentation process 103 of identifying areas of interest in a signal or image and masking out unwanted regions is conducted. In this context it refers to identifying the RF signals or pixels regions in parameter images that include the retina and choroids (or other material of interest) and masking the vitreous, sclera and orbital tissue. This is to insure wavelet statistics are based only on the tissue or material of interest.

Then, a 1-D discrete wavelet transform 104 of the RF line is conducted. The wavelet transform is a time/frequency or time/scale decomposition method for a discretely sampled function such as an RF line. An RF line may also be processed as an approximation of a continuous function using implementations of the continuous wavelet transforms (CWT). Decomposition is performed with scaled and translated forms of a single parent wavelet (an analysis function that is well localized in time and space) and is used to explore the multiresolution signal content. A number of different wavelet families with specific functional parameters may be used to optimize decomposition for a specific analysis. The improved time frequency/scale localization of wavelets has advantages in the analysis of retina and choroid RF echoes where limited resolution cells are available at useful transducer frequencies.

In 1-D processing, a transducer is lined on a single point of the vascular tissue or material of interest, which then emits an acoustic pulse. The sound reflects off the vascular tissue (backscatter echoes) and comes back to the transducer. Ultrasound backscatter echo carries information about the multicomponent scattering structure. Voltages are generated by the backscatter echoes, which are then stored as transducer voltage data. The transducer is then aligned at another point of the vascular tissue, and the process is repeated depending on the size of the sample being analyzed. This process 104 is repeated until the last RF line 105 in the ensemble is complete. Alternatively, an array of transducers with beam-forming can interrogate multiple points of the vascular tissue, so the process can be performed in significantly reduced time.

Once the last RF line 105 is completed, all of the data is stored in the Wavelet Coefficient Database 106. Wavelet decomposition uses the wavelet bases to linearly transform the ultrasound signal or parameter data to a multiresolution quad-tree structure, or a more complete structure using the CWT, with a sparse coefficient representation. In other words, the transformed ultrasound data is represented by a few very large coefficients with most coefficients near zero at the various scale levels. The coefficient database holds the multiple 1-D transforms for the ensemble of RF data.

At 107, Wavelet Statistical Modeling is performed. The correlation structure of the multi-scale, multi-locality wavelet representation of for instance ultrasound data from the retina and choroid is sensitive to local changes in tissue micro-architecture during the development of any disease. This correlation structure is related to the distribution of sub-resolvable ultrasound scatterers as measured by the persistence of wavelet coefficients within and between scales, and between locations. A wide variety of statistical models may be used to evaluate these changes. They include joint Gaussian models, joint non-Gaussian and independent formulations and a number of hybrid approaches using Hidden Markov Models, Independent Component Analysis, Bayesian formulations (directed acyclic graphs) or machine learning methods.

Following statistical modeling 107, descriptive statistics and covariance structures for specific data distributions or classifier data provided by the models are stored in Wavelet Statistics Database 108 prior to calculation of statistical maps by application to coefficient data or for further analysis in classifier formulations. At Wavelet Statistics Parameter Images 109, images or maps are created where reconstructions of normalized wavelet coefficients or statistical parameters from 108 are encoded in a gray-scale or color look-up table.

At this data representation stage after 107, there are 3 choices: ensemble descriptive statistics can be obtained from a region of interest (for instance, the mean and S.D. of the inter-level persistence of horizontal coefficients) from 108, a raw spatial map of this property (109) can be obtained, or you could go on to step 110 and apply an additional hypothesis test (110) to 109. The data can be represented in each of these ways for different reasons and the data can be used for further statistical or image analysis.

At Test Statistics 110, various hypothesis testing arrangements can be applied to local cliques of RF data or pixel data or to statistical maps created by applying specific filters to wavelet data.

Wavelet data from 108, 109 or 110 can be used alone and in combination with clinical and other imaging data to evaluate for instance AMD in terms of classification 111 using a wide variety of classical statistical methods and graphic models. Alternatively, a statistical image used to localize a given feature identified by estimation or hypothesis testing can be provided at Local Probability Images 112. Then, the status 113 of the material or tissue of interest can be determined.

In FIGS. 2A and 2B, 2-D wavelet parameter image processing is provided for. If at 102 in FIG. 1A it is determined that 2-D processing is required after the RF Ultrasound Data Scan 100, then Short Window Fast Fourier Transform (SW-FFT) or Wavelet Transform (WT) for Parameter Image Estimation 201 is provided for. The SW-FFT method involves using the SW-FFT to estimate the frequency spectrum of each reflection and employs a Linear Least Squares Fit (LLSF) to measure the quasi-linear frequency spectrum. At 201, parameter images of the acoustic concentration and size of average scattering elements can be obtained using short-windowed fast Fourier transform power spectrum analysis or wavelet transform estimation of RF tissue echo signal data. With normalization against the known emitted pulse spectrum, the amplitude of backscatter can be determined as a function of frequency within the bandwidth of the transducer independent of system characteristics.

This information can then be used in conjunction with mathematical models to estimate effective scatterer diameter and CQ², where C represents scatterer concentration (scatterers/unit volume) and Q represents the relative impedance of the scatterers. These parameters are computed from the linear best fit equation to the normalized power spectrum, which is generally quasi-linear in form. Another parameter that can be generated from this is midband-fit, which is the amplitude of the best-fit equation at the center frequency. Parameter images representing the spatial distribution of any of the above parameters can be produced by performing spectral analyses on consecutive gated regions within the image. See E. J. Feleppa, F. L. Lizzi, D. J. Coleman and M. M. Yaremko, “Diagnostic spectrum analysis in opthalmology: A physical perspective,” Ultrasound in Medicine & Biology, vol. 12, pp. 623-631, 1986, F. L. Lizzi, M. Astor, E. J. Feleppa, M. Shao and A. Kalisz, “Statistical framework for ultrasonic spectral parameter imaging,” Ultrasound in Medicine & Biology, vol. 23, pp. 1371-1382, 1997, and F. L. Lizzi, M. Astor, A. Kalisz, T. Liu, D. J. Coleman, R. Silverman, R. Ursea, and M. Rondeau, “Ultrasonic spectrum analysis for assays of different scatterer morphologies: theory and very-high frequency clinical results,” Ultrasonics Symposium, vol. 2, pp. 1155-1159, 1996. Pixel intensity or color can then be used to represent the value of the parameter, rather than the value of the signal envelope.

For input into the 2-D wavelet processing stream 203, we use Multiple Ultrasound Parameter Images 202 described above. The mid-band flow (MBF) image is also used as the structural image for image fusion formation (see below). The mid-band fit is used as a structural image and goes directly to the image fusion step without wavelet processing.

Then, 2-D discrete wavelet transform (DWT) is performed of individual parameter images. The 2-D DWT is the natural time/frequency or time/scale decomposition extension of the 1-D DWT for an image or data matrix. The scaled and translated wavelet produces a series of coefficient sub-bands at various decomposition levels along with an approximation sub-band. Horizontal, vertical and diagonal as well as non-orthogonal sub-band coefficients can be produced.

After segmentation of retinal-choroidal complex 204 (as described in 103), the transform coefficients are held in the Multiresolution Analysis Database 205. The multiresolution database 205 is the data structure for 2-D DWT data from multiple parameter images of the same RF data scan for further statistical processing. The multiresolution analysis database holds the multiple 2-D transforms for the parameter image data at this stage of the processing.

At 206, Wavelet Statistical Modeling is performed. The correlation structure of the multi-scale, multi-locality wavelet representation of ultrasound data from for instance the retina and choroid is sensitive to local changes in tissue micro-architecture during the development of AMD. This correlation structure is related to the distribution of sub-resolvable ultrasound scatterers as measured by the persistence of wavelet coefficients within and between scales, and between locations. A wide variety of statistical models may be used to evaluate these changes. They include joint Gaussian models, joint non-Gaussian and independent formulations and a number of hybrid approaches using Hidden Markov Models, Independent Component Analysis, Bayesian formulations (directed acyclic graphs) or machine learning methods.

Following wavelet statistical modeling 206, at Wavelet Statistics Parameter Images 207, using hypothesis testing or estimation techniques, images or maps are created where reconstructions of normalized wavelet coefficients are encoded in a gray-scale or color look-up table. The wavelet statistics parameter images then either go through image fusion 208, or through test statistics 209. At test statistics 209, various hypothesis testing arrangements can be applied to local cliques of RF data or pixel data or to statistical maps created by applying specific filters to wavelet data so variance is unity.

At this data representation stage after 206, a raw spatial map of this property (207) can be obtained, or you could go on to step 209 and apply an additional hypothesis test (209) to 207. The data can be represented in each of these ways for different reasons and the data can be used for further statistical or image analysis.

After the testing arrangements, beyond estimation and hypothesis testing of wavelet analysis data to directly evaluate micro-structural changes in the retina and choroid, this data can be used alone and in combination with clinical and other imaging data to evaluate AMD in terms of classification 210 using a wide variety of classical statistical methods and graphic models. Alternatively, a statistical image used to localize a given feature identified by estimation or hypothesis testing can be provided at Local Probability Images 211. Then, the status 212 of the material or tissue of interest can be determined.

The purpose of image fusion 208 is to combine a series of images from multiple sensors (in the present invention a wavelet statistical image with an ultrasound structural image) to produce a single image where the fused image should have more complete information which is more useful for human or machine perception. This operation merges the wavelet decompositions of the statistical image and the structural applying a Markov Random Field (MRF) clique maximum likelihood estimator or other image fusion algorithm to approximations coefficients and details coefficients. After image fusion 208, the AMD status 212 can be determined.

The present invention provides an improved resolution of scattering structure by using wavelet decomposition for better time and frequency localization. The wavelet analysis uses approximating functions that are contained neatly in finite (time/frequency) domains (have localized support).

Wavelet analysis is a mathematical model for assessing local changes in the profile of time-series signals. Wavelet analysis is one of the time-frequency domain analyses of signals. This method discriminates a local unique wave pattern within a complex signal. Wavelet analysis is a signal-processing tool that enables the detection of a special geometric pattern within a localized area of a signal. A wavelet is a short segmental waveform of limited duration that has an average value of zero. Wavelet analysis involves the breaking up of a signal into shifted and scaled versions of the original (or mother) wavelet. The continuous wavelet transform is defined as the sum over time of the signal multiplied by scaled, shifted versions of the wavelet function:

$$C ( scale , position ) = {\int }_{- ∞}^{∞} f ( t ) ψ ( scale , position , t ) d t$$

as defined in Journal of the American College of Cardiology, vol. 45, no. 12, pp. 1954-1960, 2005, A. Murashige, T. Hiro, T. Fujii, K. Imoto, T. Murata, Y. Fukumoto, and M. Matsuzaki, “Detection of Lipid-Laden Atherosclerotic Plaque by Wavelet Analysis of Radiofrequency Intravascular Ultrasound Signals: In Vitro Validation and Preliminary In Vivo Application”, which is herein incorporated by reference. This results in many wavelet coefficients, C, which are a function of scale and position. Multiplying each coefficient by the appropriately scaled and shifted wavelet yields the constituent wavelets of the original signal. Wavelet analysis then produces a time-scale view of a signal. “Scaling a wavelet” means stretching (or compressing) it. The greater the scale factor, the more the wavelet is stretched. This scale is related to the frequency of the signal. “Shifting a wavelet” simply means delaying (or hastening) its onset.

The steps performed to obtain a wavelet analysis are:
1. Take a wavelet and compare it to a section at the start of the original signal.
2. Calculate C, the coefficient between the section and the wavelet, which represents how closely correlated the wavelet is with this section of the signal. The higher C is, the greater the similarity. The results will depend on the shape of the wavelet selected.
3. Shift the wavelet to the right and repeat steps 1 and 2 until the whole signal is covered.
4. Scale (stretch) the wavelet and repeat steps 1 through 3.
5. Repeat steps 1 through 4 for all scales.

This process produces wavelet coefficients (C) that are a function of scale and position. After taking these steps, the coefficients are produced at different scales by different sections of the signal. The coefficients constitute a regression of the original signal performed on the wavelets.

Continuous Wavelet Transform (CWT) for R.F. ultrasound data are further described in Georgiou, G., et al., “Tissue Characterization Using the Continuous Wavelet Transform Part I: Decomposition Method,” IEEE Trans Ultra Freq Cons., 48:355-363 (2001), which is herein incorporated by reference.

The Discrete Wavelet Transform (DWT) in contrast to the Continuous Wavelet Transform (CWT) is performed by stretching the wavelet ad dyadic levels of scale and providing a discrete decomposition, as described in Wan, S., et al., “Robust Deconvolution of High-Frequency Ultrasound Images Using Higher-Order Spectral Analysis and Wavelets,” IEEE Trans Ultra Freq Cons., 50:1286-1295 (2003), which is herein incorporated by reference. Here, DWT is used as a means of deconvolution and denoising (in combination with a bicepstrum estimate of the system transfer function) of high-frequency ultrasound signals to improve the resolution of gray-scale images of skin.

Wavelet analysis provides several advantages over other similar processes. Wavelet analysis is one model that provides a time-frequency domain analysis of signals. Fourier analysis is another model that provides a time-frequency domain analysis of signals, and which breaks down a signal into constituent sinusoids of different frequencies. The Fourier transform was modified into a transform to analyze only a small section of the signal at a time by looking at “windows” of the signal. This short-time Fourier transform provides some information about when and at what frequencies a signal event occurs. The major drawback of this method is that once a particular size for the time window is chosen, that window is the same for all frequencies. If the window size is changed to a shorter one to increase time (space) resolution, the frequency resolution is compromised. Further, sine and cosine functions are non-local (and stretch out to infinity), and therefore do a very poor job in approximating sharp spikes. Wavelet analysis was proposed in an attempt to overcome the problems in resolution.

Wavelet analysis represents a windowing technique with variable-sized regions. Wavelet analysis allows the use of long-time intervals when more precise low-frequency information is needed and shorter regions when high-frequency information is needed. One major advantage of wavelets is their ability to analyze a localized area of a larger signal. Wavelet transforms are compactly supported, providing improved spatial localization.

The above description of the present invention is only the preferred embodiment of the invention. Embodiments may include any currently or hereafter-known versions of the elements described herein. Further, the present invention is not limited to ophthalmic applications, and can be used to assess the three dimensional structure of any type of vascular tissue.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method of ultrasound imaging and analysis of a material of interest, the method comprising:
conducting an ultrasound scan of the material of interest using a transducer that emits an acoustic signal;
receiving a backscattered signal from a region in the material of interest;
collecting transducer voltage data along an individual line of sight to form a one-dimensional array of radio frequency data; and
applying a wavelet transform to the one-dimensional array of radio frequency data, where a transform function is determined by the properties of the material of interest.

2. The method of ultrasound imaging and analysis of a material of interest of claim 1, where the material of interest is the choroid of an eye.

3. The method of ultrasound imaging and analysis of a material of interest of claim 1, further comprising identifying areas of interest in the scatter signal and masking out unwanted regions.

4. The method of ultrasound imaging and analysis of a material of interest of claim 1, where the wavelet transform comprises applying a one-dimensional wavelet transform to transform the radio frequency data to a multiresolution quad-tree structure with a sparse coefficient representation.

5. The method of ultrasound imaging and analysis of a material of interest of claim 4, further comprising storing coefficients in a wavelet coefficient database.

6. The method of ultrasound imaging and analysis of a material of interest of claim 5, further comprising evaluating changes between the wavelet coefficients using wavelet statistical modeling.

7. The method of ultrasound imaging and analysis of a material of interest of claim 6, where the statistical modeling is performed from a process selected from a group consisting of: joint Gaussian models, joint non-Gaussian models, Hidden Markov models, independent component analysis and Bayesian formulations.

8. The method of ultrasound imaging and analysis of a material of interest of claim 6, further comprising storing descriptive statistics and covariance structures for specific data distributions provided by the statistical modeling.

9. The method of ultrasound imaging and analysis of a material of interest of claim 6, further comprising creating images or maps using hypothesis testing or estimation techniques, where reconstructions of normalized wavelet coefficients are encoded.

10. The method of ultrasound imaging and analysis of a material of interest of claim 8, further comprising applying various hypothesis testing arrangements to local cliques of data by applying specific filters to wavelet data.

11. The method of ultrasound imaging and analysis of a material of interest of claim 10, further comprising classifying the wavelet data.

12. The method of ultrasound imaging and analysis of a material of interest of claim 11, further comprising determining a status of the material of interest using the wavelet data.

13. A method of ultrasound imaging and analysis of a material of interest, the method comprising:
conducting an ultrasound scan of the material of interest using a transducer that emits an acoustic signal;
receiving a backscattered signal from a region in the material of interest;
collecting transducer voltage data along multiple lines of sight to form a two-dimensional array of radio frequency data; and
applying a wavelet transform to the two-dimensional array of radio frequency data, where a transform function is determined by the properties of the material of interest.

14. The method of ultrasound imaging and analysis of a material of interest of claim 13, further comprising obtaining parameter images of the backscatter radio frequency data using short-windowed fast Fourier transform or wavelet transform.

15. The method of ultrasound imaging and analysis of a material of interest of claim 14, further comprising inputting the parameter images into a two-dimensional wavelet processing stream.

16. The method of ultrasound imaging and analysis of a material of interest of claim 15, further comprising applying a two-dimensional discrete wavelet transform of the parameter images to produce a series of coefficient sub-bands.

17. The method of ultrasound imaging and analysis of a material of interest of claim 16, further comprising storing the coefficient sub-bands in a multiresolution analysis database.

18. The method of ultrasound imaging and analysis of a material of interest of claim 17, further comprising evaluating changes between the wavelet coefficients using wavelet statistical modeling.

19. The method of ultrasound imaging and analysis of a material of interest of claim 18, where the statistical modeling is performed from a process selected from a group consisting of: joint Gaussian models, joint non-Gaussian models, Hidden Markov models, independent component analysis and Bayesian formulations.

20. The method of ultrasound imaging and analysis of a material of interest of claim 17, further comprising creating images or maps using hypothesis testing or estimation techniques, where reconstructions off normalized wavelet coefficients are encoded.

21. The method of ultrasound imaging and analysis of a material of interest of claim 20, further comprising applying various hypothesis testing arrangements to local cliques of data by applying specific filters to wavelet data.

22. The method of ultrasound imaging and analysis of a material of interest of claim 21, further comprising classifying the wavelet data.

23. The method of ultrasound imaging and analysis of a material of interest of claim 21, further comprising determining a status of the material of interest using the wavelet data.

24. The method of ultrasound imaging and analysis of a material of interest of claim 20, further comprising combining the images to produce a single fused image.

25. The method of ultrasound imaging and analysis of a material of interest of claim 24, further comprising determining the status of the material of interest using the single fused image.

26. A high resolution imaging system for imaging a material of interest, the system comprising:
a transducer for emitting an acoustic signal and receiving a backscattered signal from a region in the material of interest;
a data processing system for:
acquiring radio frequency data along multiple lines of sight to from a two dimensional array of radio frequency data;
applying a wavelet transform to the radio frequency data to form several images of the data; and
forming a single fused image from the several images; and
a display for displaying the single fused image to determine a status of the material of interest.
